(19) United States
(12) Patent Application Publication
(10) Pub. No.: US 2008/0192570 A1
(43) Pub. Date: Aug. 14, 2008

(54) Lateral force and depth control device for marine seismic sensor array

(76) Inventors: Stig Rune Lennart Tenghamn, Katy, TX (US); Steven J. Maas, Pfugerville, TX (US); Jon Falkenberg, Jar (NO); D. Richard Metzbower, Austin, TX (US)

Correspondence Address: E. Eugene Thigpen;Petroleum Geo-Services, Inc., P.O. Box 42805, Houston, TX, 77242-2805, US

(21) Appl. No.: 11/706,750

(22) Filed: Feb. 14, 2007

(51) Int. Cl. G01V 1/38

(52) U.S. Cl. 367/17

(57) ABSTRACT

A lateral force and depth control device for a seismic streamer includes an inner housing including a coupling at each longitudinal end thereof. The couplings are configured to mate with a corresponding coupling at a longitudinal end of a streamer segment. The device includes an outer housing rotatably supported on the inner housing. A signal communication device is configured to transfer at least one of electrical power and signals between the inner housing and the outer housing while enabling relative rotation therebetween. A plurality of control surfaces are rotatably coupled to the outer housing and arranged about the circumference of the outer housing. The control surfaces are coupled to the outer housing by releasable couplings. A first controllable actuator and a second controllable actuator are disposed in the outer housing and functionally coupled to at least a first and a second one of the control surfaces, respectively.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of marine seismic surveying. More particularly, the invention relates to devices for controlling lateral position and depth of seismic streamers.

2. Background Art

Marine seismic surveying systems are used to acquire seismic data from Earth formations below the bottom of a body of water, such as a lake or the ocean. Marine seismic surveying systems typically include a seismic vessel having onboard navigation, seismic energy source control, and data recording equipment. The seismic vessel is typically configured to tow one or more streamers through the water. At selected times, the seismic energy source control equipment causes one or more seismic energy sources (which may be towed in the water by the seismic vessel or by another vessel) to actuate. Signals produced by various sensors on the one or more streamers are ultimately conducted to the recording equipment, where a record with respect to time is made of the signals produced by each sensor (or groups of such sensors). The recorded signals are later interpreted to infer the structure and composition of the Earth formations below the bottom of the body of water.

The one or more streamers are in the most general sense long cables that have seismic sensors disposed at spaced apart positions along the length of the cables. A typical streamer can extend behind the seismic vessel for several kilometers. Because of the great length of the typical streamer, the streamer may not travel entirely in a straight line behind the seismic vessel at every point along its length due to interaction of the streamer with the water and currents in the water, among other factors.

More recently, marine seismic acquisition systems have been designed that include a plurality of such streamers towed by the seismic vessel in parallel. The streamers are towed by the vessel using towing devices, and associated equipment that maintain the streamers at selected lateral distances from each other as they are towed through the water. Such multiple streamer systems are used in what are known as three dimensional and four dimensional seismic surveys. A four dimensional seismic survey is a three dimensional survey over a same area of the Earth's subsurface repeated at selected times. The individual streamers in such systems are affected by the same forces that affect a single streamer.

The quality of images of the Earth's subsurface produced from three dimensional seismic surveys is affected by how well the positions of the individual sensors on the streamers are controlled. The quality of images generated from the seismic signals also depends to an extent on the relative positions of the seismic receivers being maintained throughout the seismic survey. Various devices are known in the art for positioning streamers laterally and/or at a selected depth below the water surface. U.S. Pat. No. 5,443,027 issued to Owsley et al., for example, describes a lateral force device for displacing a towed underwater acoustic cable that provides displacement in the horizontal and vertical directions. The device has a hollow spool and a rotationally mounted winged fuselage. The hollow spool is mounted on a cable with cable elements passing therethrough. The winged fuselage is made with the top half relatively positively buoyant and the bottom half relatively negatively buoyant. The winged fuselage is mounted about the hollow spool with clearance to allow rotation of the winged fuselage. The difference in buoyancy between the upper and lower fuselage maintains the device in the correct operating position. Wings on the fuselage are angled to provide lift in the desired direction as the winged fuselage is towed through the water. The device disclosed in the Owsley et al. patent provides no active control of direction or depth of the streamer, however.

U.S. Pat. No. 6,011,752 issued to Ambs et al. describes a seismic streamer position control module having a body with a first end and a second end and a bore therethrough from the first end to the second end for receiving a seismic streamer. The module has at least one control surface, and at least one recess in which is initially disposed the at least one control surface. The at least one control surface is movably connected to the body for movement from and into the at least one recess and for movement, when extended from the body, for attitude adjustment. Generally, the device described in the Ambs et al. patent is somewhat larger diameter, even when closed, than the streamer to which it is affixed, and such diameter may become an issue when deploying and retrieving streamers from the water.

U.S. Pat. No. 6,144,342 issued to Bertheas et al. describes a method for controlling the navigation of a towed seismic streamer using “birds” affixable to the exterior of the streamer. The birds are equipped with variable-incidence wings and are rotatably fixed onto the streamer. Through a differential action, the wings allow the birds to be turned about the longitudinal axis of the streamer so that a hydrodynamic force oriented in any given direction about the longitudinal axis of the streamer is obtained. Power and control signals are transmitted between the streamer and the bird by rotary transformers. The bird is fixed to the streamer by a bore closed by a cover. The bird can be detached automatically as the streamer is raised so that the streamer can be wound freely onto a drum. The disclosed method purportedly allows the full control of the deformation, immersion and heading of the streamer.

There continues to be a need for a lateral force and depth control device for marine seismic streamers to maintain depth and heading of the streamers along their length.

### SUMMARY OF THE INVENTION

One aspect of the invention is a lateral force and depth control device for a seismic streamer. Such a device includes an inner housing including a coupling at each longitudinal end thereof. The couplings are configured to mate with a corresponding coupling at a longitudinal end of a streamer segment. The device includes an outer housing rotatably supported on the inner housing. A signal communication device is configured to transfer at least one of electrical power and signals between the inner housing and the outer housing while enabling relative rotation therebetween. A plurality of control surfaces are rotatably coupled to the outer housing and arranged about the circumference of the outer housing. The control surfaces are coupled to the outer housing by releasable couplings. A first controllable actuator and a second controllable actuator are disposed in the outer housing and functionally coupled to at least a first and a second one of the control surfaces, respectively.

Another aspect of the invention is a seismic sensor system. A system according to this aspect of the invention includes a plurality of seismic streamers deployed behind the seismic vessel and laterally spaced apart from each other. Each streamer includes a plurality of seismic sensors disposed at spaced apart positions along each streamer. Each streamer includes at least one lateral force and depth control device. Each of the lateral force and depth control devices includes an inner housing including a coupling at each longitudinal end thereof. The couplings are configured to mate with a corresponding coupling at a longitudinal end of a streamer segment. The device includes an outer housing rotatably supported on the inner housing. A signal communication device is configured to transfer at least one of electrical power and signals between the inner housing and the outer housing while enabling relative rotation therebetween. A plurality of control surfaces are rotatably coupled to the outer housing and arranged about the circumference of the outer housing. The control surfaces are coupled to the outer housing by releasable couplings. A first controllable actuator and a second controllable actuator are disposed in the outer housing and functionally coupled to at least a first and a second one of the control surfaces, respectively.

A method for operating a seismic acquisition system according to another aspect of the invention includes towing a plurality of laterally separated streamers behind a vessel. At least one of a geodetic position and a lateral distance between streamers is determined at selected positions along the length of the streamers. A lateral force and depth control device proximate at least one of the selected positions is operated to maintain relative lateral positions of the streamers along the lengths thereof.

Other aspects and advantages of the invention will be apparent from the following description and the appended claims.

### BRIEF DESCRIPTION OF THE DRAWINGS

FIG. 1 shows a marine seismic acquisition system using lateral force and depth (“LFD”) control devices according to one embodiment of the invention.

FIG. 2 shows an oblique view of one of the LFD control devices affixed to a streamer.

FIG. 3 shows a cross section of an inner housing of the LFD control device and how it couples to streamers.

FIG. 4 shows a side view cross section of an outer housing of an LFD control device.

FIG. 4A shows alternative operating and control circuitry for an embodiment of LFD control device that is self-correcting.

FIG. 4B shows an alternative embodiment of actuator used in the control device of FIG. 4A.

FIG. 4C shows an example acoustic distance measuring device that may be used to maintain streamers at constant lateral separation over their length.

FIG. 5 shows an end view cross section of an outer housing of an LFD control device.

FIG. 5A shows an embodiment of inner housing and outer housing using slip rings for electrical communication between housings.

FIG. 6 shows one example of a “quick connect” used to couple one of a plurality of control surfaces to the outer housing of an LFD control device.

### DETAILED DESCRIPTION

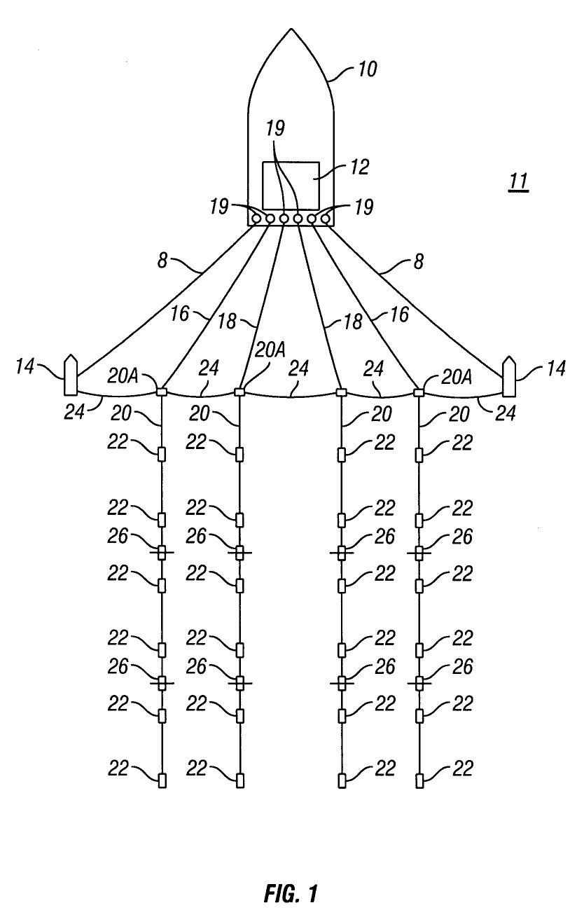

FIG. 1 shows a typical marine seismic survey system that can include a plurality of streamers. Each of the streamers can be guided through the water by one or more lateral force and depth (“LFD”) control devices cooperatively engaged with each of the streamers. The seismic survey system includes a seismic vessel 10 that moves along the surface of a body of water 11 such as a lake or the ocean. The seismic vessel 10 may include thereon equipment, shown at 12 and for convenience collectively called a “recording system.” The recording system 12 typically includes a recording unit for making a record with respect to time of signals generated by various seismic sensors in the acquisition system. The recording system 12 also typically includes navigation equipment to determine at any time the position of the vessel 10 and each of a plurality of seismic sensors 22 disposed at spaced apart locations on streamers 20 towed by the vessel 10. The foregoing elements of the recording system 12 are familiar to those skilled in the art and are not shown separately in the figures herein for clarity of the illustration.

The seismic sensors 22 can be any type of seismic sensor known in the art such as motion responsive sensors, acceleration sensors, pressure sensors, pressure time gradient sensors or any combination thereof. The seismic sensors 22 measure seismic energy primarily reflected from various structures in the Earth's subsurface below the bottom of the water 11. The seismic energy originates from a seismic energy source (not shown) deployed in the water 11. The seismic energy source (not shown) may be towed in the water 11 by the seismic vessel 10 or a different vessel (not shown). The recording system 12 may also include seismic energy source control equipment (not shown separately).

In the seismic survey system shown in FIG. 1, there are four seismic sensor streamers 20 towed by the seismic vessel 10. The number of seismic sensor streamers may be different in any particular implementation of a survey system according to the various aspects of the invention, therefore, the number of streamers such as shown in FIG. 1 is not intended to limit the scope of the invention. As explained in the Background section herein, in seismic acquisition systems such as shown in FIG. 1 that include a plurality of laterally spaced apart streamers, the streamers 20 are coupled to towing equipment that secures the forward ends of the streamers 20 at selected lateral positions with respect to each other and with respect to the seismic vessel 10. As shown in FIG. 1, the towing equipment can include two paravane tow ropes 8 each coupled to the vessel 10 at one end through a winch 19 or similar spooling device that enables changing the deployed length of each paravane tow rope 8. The distal end of each paravane tow rope 8 is functionally coupled to a paravane 14. The paravanes 14 are each shaped to provide a lateral component of motion to the various towing components deployed in the water 11 when the paravanes 14 are moved through the water 11. Lateral in the present context means transverse to the direction of motion of the vessel 10. The lateral motion component of each paravane 14 is opposed to that of the other paravane 14, and is generally in a direction transverse to the centerline of the vessel 10. The combined lateral motion of the paravanes 14 separates the paravanes 14 from each other until they put into tension one or more spreader ropes or cables 24, functionally coupled end to end between the paravanes 14.

The streamers 20 are each coupled, at the axial end thereof nearest the vessel 10, to a respective lead-in cable termination 20A. The lead-in cable terminations 20A are coupled to or are associated with the spreader ropes or cables 24 so as to fix the lateral positions of the streamers 20 with respect to each other and with respect to the vessel 10. Electrical and/or optical connection between the appropriate components in the recording system 12 and, ultimately, the sensors 22 (and/or other circuitry) in the ones of the streamers 20 inward of the lateral edges of the system may be made using inner lead-in cables 18, each of which terminates in a respective lead-in cable termination 20A. A lead-in termination 20A is disposed at the vessel end of each streamer 20. Corresponding electrical and/or optical connection between the appropriate components of the recording unit 12 and the sensors in the laterally outermost streamers 20 may be made through respective lead-in terminations 20A, using outermost lead-in cables 16. Each of the inner lead-in cables 18 and outermost lead-in cables 16 may be deployed by a respective winch 19 or similar spooling device such that the deployed length of each cable 16, 18 can be changed.

The system shown in FIG. 1 also includes a plurality of LFD control devices 26 cooperatively engaged with each of the streamers 20 at selected positions along each streamer 20. As will be further explained, each LFD control device 26 includes rotatable control surfaces that when moved to a selected rotary orientation with respect to the direction of movement of such surfaces through the water 11 creates a hydrodynamic lift in a selected direction to urge the streamer 20 in any selected direction upward or downward in the water 11 or transverse to the direction of motion of the vessel. Thus, such LFD control devices 26 can be used to maintain the streamers in a selected geometric arrangement.

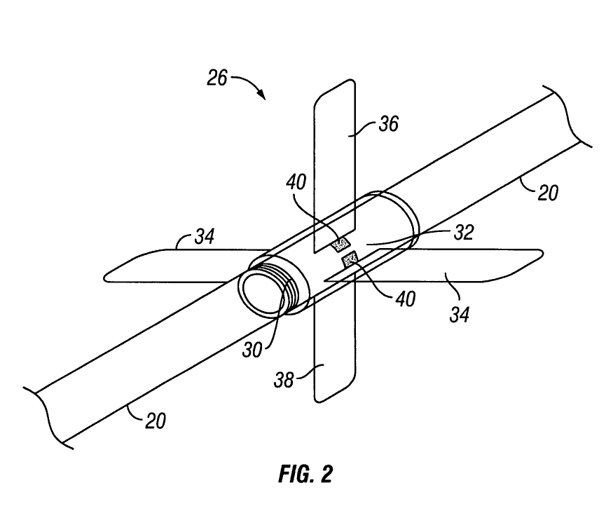

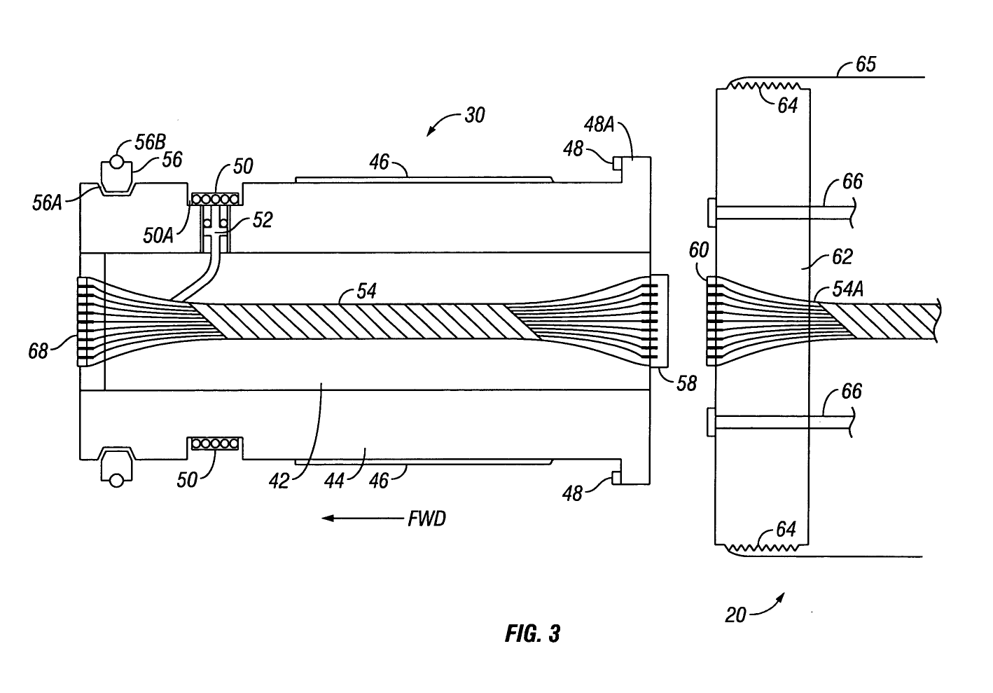

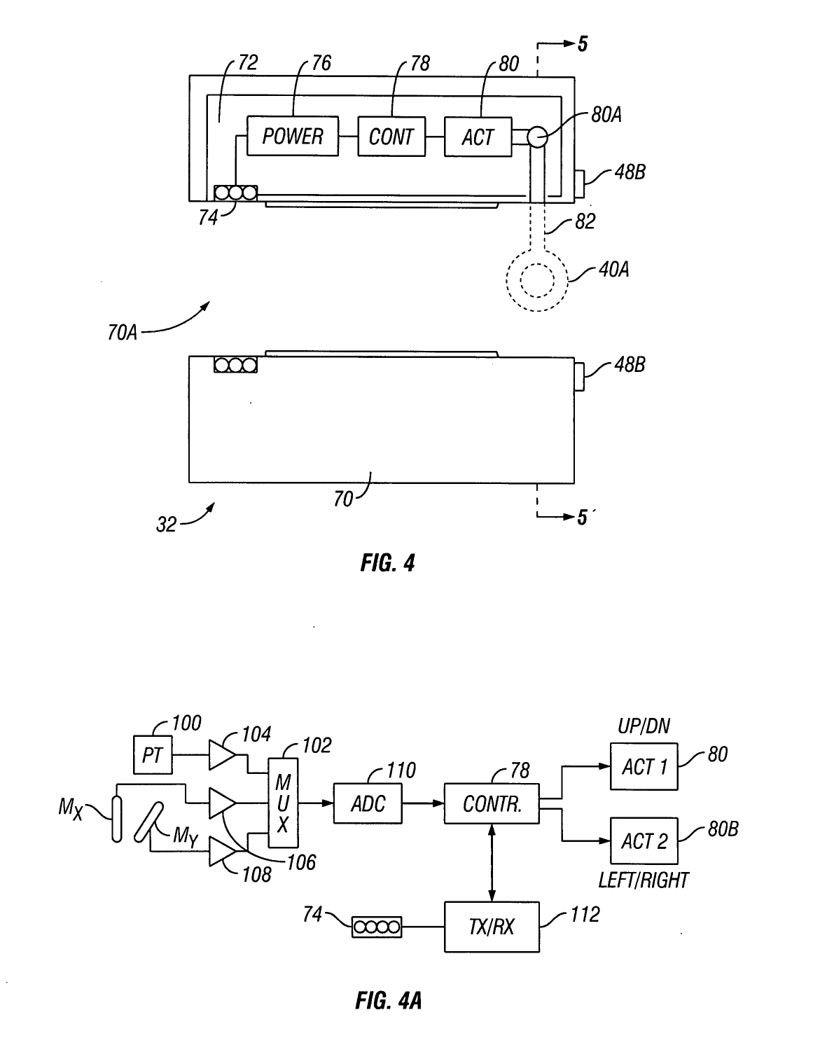

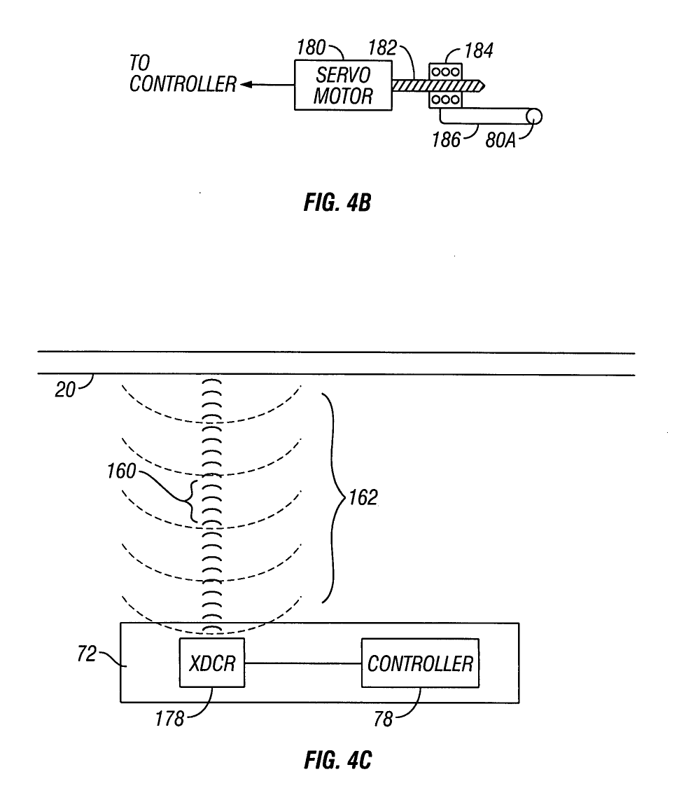

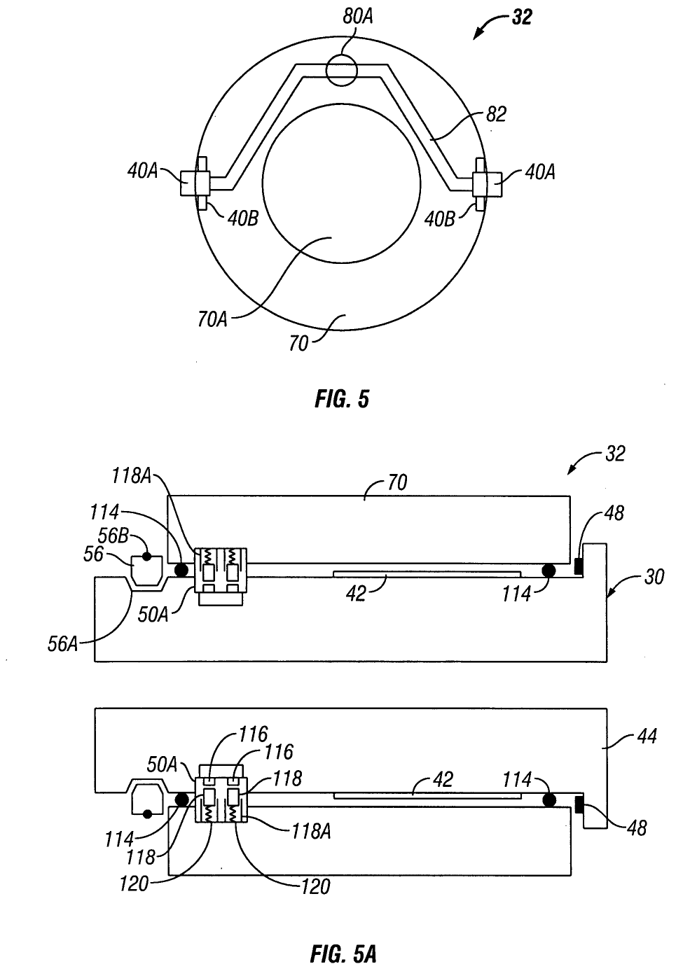

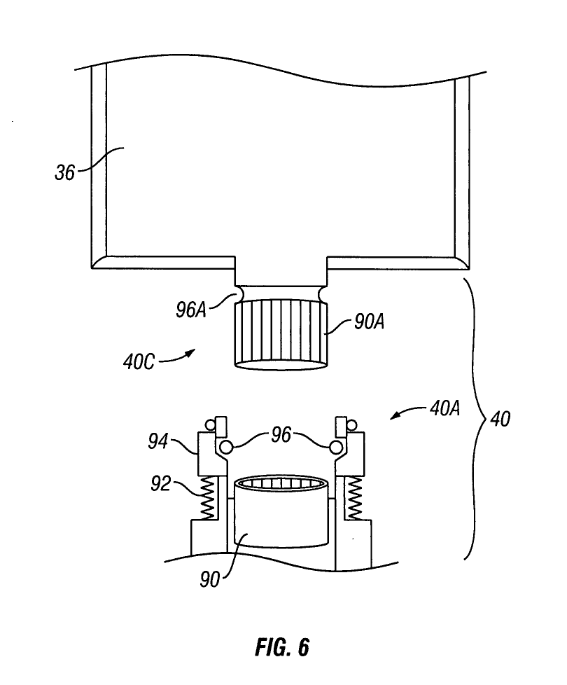

FIG. 2 shows an oblique view of one embodiment of the LFD control devices 26 as it is coupled to a streamer 20. As will be appreciated by those skilled in the art, a typical streamer is formed by coupling together end to end a plurality of streamer segments. Each streamer segment includes terminations at each longitudinal end. Each such termination may be coupled to a corresponding termination at one longitudinal end of another such streamer segment. The terminations typically include electrical and/or optical couplings to enable power and/or signal communication between electrical and/or optical cables disposed in each streamer segment. The terminations also include a feature for coupling the termination to one or more strength members in each streamer segment and thus transmit axial load from one streamer segment to the next through the interconnected terminations. In the present embodiment, the LFD control device 26 forms a coupling that may be disposed between the terminations of two streamer segments. The LFD control device 26 may include an outer housing 32 rotatably affixed to an inner housing 30. As will be further explained below with reference to FIG. 3, the inner housing 30 may include terminations similar to those on the streamer segments, such that the cables in each streamer segment may be in electrical and/or optical communication with each other through corresponding cabling in the LFD control device 26, and axial load may be transmitted between the segments through the inner housing 30. The outer housing 32 may include about its circumference four, substantially orthogonally disposed control surfaces 34, 36 and 38. The control surfaces 34, 36, 38 may be planar, or may have a generally airfoil shaped cross section to reduce turbulence as the LFD control device 26 is moved through the water (11 in FIG. 1). The control surfaces 34, 36, 38 are coupled to the outer housing 32 using quick connects 40 that will be explained in more detail with reference to FIG. 6. The quick connects 40 provide the system user with the ability to rapidly install and remove all the control surfaces 34, 36, 38 from the outer housing 32 during deployment and retrieval of a streamer having such LFD control devices 26 included therein. The outer housing 32 includes therein devices, to be explained in more detail with reference to FIGS. 4 and 5, that cause the control surfaces 34, 36, 38 to rotate about axes that may be substantially perpendicular to the longitudinal axis of the outer housing 32. and in the plane of each control surface 34, 36, 38.

In the present embodiment, the control surface 36 shown in the uppermost position may be positively buoyant. The control surface 38 shown in the lowermost position may be negatively buoyant. The two control surfaces 34 shown in approximate horizontal orientation may be substantially neutrally buoyant. Such arrangement of buoyancy of the various control surfaces 34, 36, 38 provides that the outer housing 32 will remain substantially in the rotary orientation shown in FIG. 2 notwithstanding the effects of torque on the streamer during operation that may cause the inner housing 30 to rotate correspondingly.

FIG. 2 shows the control surfaces in a neutral position, wherein the plane of each control surface is substantially along the direction of motion of the streamer through the water. Rotation of the vertically oriented control surfaces 36, 38 may be used to affect lateral direction of the streamer, and rotation of the horizontally oriented control surfaces 34 may be used to affect the depth (vertical direction) of the streamer. The manner in which such rotation is performed, and devices used to perform such rotation will be further explained with reference to FIGS. 4 and 5.

In some implementations, the dimensions of the inner housing 30 and outer housing 32 are selected such that when the control surfaces 34, 36, 38 are removed using the quick connects 40, the external diameter of the outer housing 32 is about the same as that of the streamer 20. It will be appreciated by those skilled in the art that the dimensions of the inner housing 30 and the outer housing 32 are ultimately selected to satisfy a variety of performance criteria. Some of the performance criteria may require dimensional considerations opposed to those of other constraints, necessitating a trade-off analysis. Examples of considerations for the housing dimensions include mechanical and electrical packaging requirements, reliability (mean time between failures) of the housings 30, 32, sealing requirements of the housings 30, 32 and strength of the materials used to make the housings 30, 32. For example, facilitating spooling of the LFD device on a winch favors smaller housing length and larger diameter, while improved water flow characteristics will be obtained using smaller housing diameter. The actual dimensions of the housings 30, 32 are ultimately a matter of discretion of the system designer.

One embodiment of the inner housing 30 is shown in side view cross section in FIG. 3. The inner housing 30 includes a generally cylindrically shaped mandrel 44 made from titanium, steel or other high strength material. In some embodiments, such as one to be explained with reference to FIG. 4A, the mandrel 44 is preferably made from a non-magnetic material such as titanium or a nickel chromium steel alloy sold under the trademark INCONEL, which is a registered trademark of Huntington Alloys Corporation, Huntington, W. Va. The mandrel 44 may have an inner through bore 42 to enable passage from one end to the other of an electrical and/or optical cable 54, or to contain electrical circuit boards or other electronic components. The cable 54 can include electrical and/or optical conductors (not shown separately) for carrying electrical power and/or signals between the streamer segments (20 in FIG. 2). The electrical and/or optical configuration of the cable 54 will depend on configuration of corresponding cable 54A in the adjoining streamer segments 20. The cable 54 terminates at each longitudinal end of the mandrel 44 in connectors 58, 68 that mate to corresponding connectors, one of which is shown at 60, in the adjoining streamer segments 20. The connectors 58, 60, 68 include contacts to make electrical and/or optical connection between individual conductors and/or optical fibers in the cable 54 disposed in the inner housing 30, and the cable 54A in the adjoining streamer segments 20. The example streamer segment 20 shown in FIG. 3 terminates using a termination plate 62 of any configuration known in the art that may include locking features 64 on the exterior surface to grip the streamer jacket 65. The termination plate 62 may also mechanically couple to the one or more strength members 66 in the streamer segment 20 so as to transfer axial load between the termination plate 62 and the strength members 66. The termination plate 62 may be affixed to a corresponding feature (not shown) on the mandrel 44 using any connection device known in the art for coupling streamer segments end to end. In some implementations, certain auxiliary electrical circuitry (not shown in the figures) such as power conditioners may be included in order to obtain electrical power from a bus line (not shown in the figures) in the streamer (20 in FIG. 1) to operate the LFD device 26 and to communicate signals from the LFD device 26 to a signal line (not shown) in the streamer (20 in FIG. 1).

It should be noted that the outer and inner diameter of the mandrel shown in FIG. 3 are intended only to illustrate the features of the mandrel 44 and are not intended to limit the diameters to those shown in FIG. 3. It is contemplated that the outer diameter of the mandrel 44 may be made as small as possible consistent the requirements for the mandrel to withstand the expected axial loading and bending stresses thereon during use. By using such a small diameter mandrel 44 it may be possible also to minimize the diameter of the outer housing (32 in FIG. 2) such that the outer housing may be made to have substantially the same outer diameter as the streamer, as explained above with reference to FIG. 2.

The mandrel 44 preferably includes a thrust flange 48A to bear axial loading exerted by the outer housing (explained in more detail with reference to FIG. 4). The thrust flange 48A may support bearings 48 such as polycrystalline diamond compact (“PDC”) buttons, roller bearings, ball bearings or any other type of bearing that will transfer the thrust load from the outer housing (32 in FIG. 2) to the inner housing 30 while enabling relatively free rotation of the outer housing (32 in FIG. 2) about the inner housing 30. The outer surface of the mandrel 44 preferably includes a radial bearing 46 affixed thereto to absorb radial loading of the outer housing (32 in FIG. 2) about the inner housing 30 while enabling free rotation thereof. The bearing 46 may be a journal bearing material such as babbitt, PDC or similar journal bearing material, or may be roller bearings or any other bearing device or element ordinarily used as a radial bearing.

As may be inferred by examining FIG. 3, the outer surface of the mandrel 44, except for the thrust flange 48A has a substantially constant external diameter. To assemble the outer housing (32 in FIG. 2) to the inner housing 30, the outer housing is longitudinally slid over the mandrel 44 at the end opposite the thrust flange 48 until a thrust end of the outer housing (not shown in FIG. 3) contacts the thrust bearing 48. The outer housing (32 in FIG. 2) may be retained in longitudinal position on the mandrel 44 by means of split rings 56 disposed in a corresponding groove 56A formed in the outer surface of the mandrel 44. The split rings 56 may be held together and thus within the groove 56A by a spring ring 56B or similar device. One such type of spring ring is sold under the trademark SPIROLOX, which is a registered trademark of Kadon Corporation, Muskegon, Mich.

In the present embodiment, electrical power and signals may be conducted from the cable 54 through the mandrel 44 to devices in the outer housing (32 in FIG. 2) by means of a communication element, which in the present embodiment includes an induction coil 50 disposed in a corresponding groove or channel 50A in the outer surface of the mandrel 44 and wound around the entire circumference of the channel 50A. A corresponding induction coil in the outer housing will be explained with reference to FIG. 4. Fluid may be excluded from entering the through bore 42 by connecting the terminals of the induction coil 50 to the cable 54 or other electrical connection inside the through bore 42 by using a sealed, feed through bulkhead electrical connector 52 of any type known in the art. Preferably, the induction coil 50 is disposed in an electrically insulating, waterproof substrate (not shown separately) to exclude fluid therefrom and to insulate the windings of the induction coil 50.

A side view cross section of the outer housing 32 is shown in FIG. 4. The outer housing 32 may be formed on a substantially cylindrical mandrel 70 and may be made from titanium, steel or other high strength material. In some embodiments, such as one to be explained with reference to FIG. 4A, the mandrel 70 is preferably made from a non-magnetic material such as titanium or the previously mentioned INCONEL alloy. The mandrel 70 may include a central bore 70A having a diameter selected to enable rotational engagement of the mandrel 70 on the exterior surface of the inner housing mandrel (44 in FIG. 3). The mandrel 70 may define on or more sealed chambers 72 therein between the outer wall and the inner wall of the mandrel 70. The chamber 72 may include various electrical circuitry, and actuation devices to rotate the control surfaces (34, 36 38 in FIG. 2). One end of the mandrel 70 includes a thrust bearing surface that may include bearings 48B such as PDC buttons or any other known thrust bearing device. The thrust bearings 48B cooperatively engage the thrust bearings (48 in FIG. 3) on the inner housing (30 in FIG. 3). The inner wall of the mandrel 70, which defines the bore 70A may rotatably engage the bearing (42 in FIG. 3) on the inner housing mandrel (44 in FIG. 3).

In the present embodiment, the chamber 72 includes therein an induction coil 74 (mentioned with reference to FIG. 3 as the corresponding induction coil) around the interior circumference of the mandrel 70 as shown in FIG. 4, arranged to be located proximate the induction coil (50 in FIG. 3) on the inner housing. The induction coil 74 provide the corresponding part of the signal communication element. Such location of the induction coil 74 provides that electrical power and control signals may be efficiently transferred between the two induction coils (50 in FIGS. 3 and 74 in FIG. 4) while the outer housing 32 is free to rotate about the inner housing (30 in FIG. 3). Electrical power transferred from the inner housing cable (54 in FIG. 3) through the induction coil 74 may be coupled to the input of a power conditioner 76. Conditioned electrical power from the conditioner 76 may be used to operate a controller 78. The controller 78 may be a microprocessor based controller, programmable logic controller (“PLC”) or a similar device and may be configured to detect control signals transmitted by the recording unit (12 in FIG. 1) to operate the LFD control device (26 in FIG. 1).

Selected control signals decoded by the controller 76 cause the controller 76 to operate one or more actuators, one of which is shown in FIG. 4 at 80, and which may be an electrically operated linear actuator such as one sold under model designation “XLA” by Specialty Motions, Inc., Corona, Calif. Motion of the actuator 80 arranged as shown in the embodiment shown in FIG. 4 is generally along the direction of the longitudinal axis of the mandrel 70. Such motion is transferred to a motion transfer element to change linear motion of the actuator to rotary motion of the control surface. In the present embodiment, such motion transfer element may include a crankshaft 82. The crankshaft 82, as will be explained with reference to FIG. 5, can extend around part of the circumference of the interior of the mandrel 70 about one quarter of the circumference in either direction from a connection 80A between the actuator 80 and the crankshaft 82. As will be explained with reference to FIG. 5, the crankshaft 82 may be rotatably supported proximate its ends and coupled at such ends to a receptacle portion of the quick connects (40 in FIG. 1), such portion being shown generally at 40A in FIG. 4. The portions of the crankshaft 82, and the portions 40A of the quick connects are shown dashed in FIG. 4 because such portions do not lie in the plane of the cross section of FIG. 4. Using the components shown in FIG. 4, linear motion of the actuator 80 is transferred to the crankshaft 82 such that the quick connect receptacle portions 40A are rotated. Such rotation is ultimately transferred to the control surfaces (34, 36 38 in FIG. 1). A possible advantage of the embodiment shown in FIG. 4 is that it provides a structure to rotate the control surfaces (34, 36 38 in FIG. 2) that traverses a relatively small radial distance, thus enabling the outer housing 32 to have a smaller external diameter than may be possible using other structures to rotate the control surfaces. Furthermore, the arrangement shown in FIG. 4 enables operating two, circumferentially opposed ones of the control surfaces substantially identically using only one actuator.

An alternative implementation to operate the control surfaces is shown in FIG. 4B. In substitution of the linear actuator shown in FIG. 4, in the present embodiment a servo motor 180 operated under control of the controller (78 in FIG. 4A) may rotate a drive screw or worm gear 182. Rotation of the worm gear 182 is translated into linear motion by a ball nut 184 movably affixed to the exterior of the worm gear 182. The ball nut 184 may be coupled by a link 186 to the connection 80A.

An end view cross section through the outer housing 32 is shown in FIG. 5 (substantially along line 5-5′ in FIG. 4) that includes the crankshaft 82, the connection to the actuator 80A, and quick connect receptacle portions 40A at the ends of the crankshaft 82 to better illustrate the manner in which linear motion of the actuator is converted to rotary motion of the quick connect receptacle portions 40A. As shown in FIG. 5, the ends of the crankshaft 82 may be rotatably supported in bearings 40B in the wall of the outer housing 32.

The components shown in FIG. 5, as operated by the components shown in FIG. 4 or 4B, may be used to operate the horizontally oriented control surfaces (34 in FIG. 1). To operate the vertically oriented control surfaces (36, 38 in FIG. 1) the components shown in FIG. 5 may be duplicated, as may be the actuator shown at 80 in FIG. 4, and all arranged circumferentially approximately at right angles (90 degrees) with respect to the components shown in FIG. 5 with respect to the circumference of the outer housing 32.

The foregoing embodiment may rely on signals transmitted from the recording unit (12 in FIG. 1) to operate the controller (78 in FIG. 4), and consequently to operate the actuators 80 to change the depth and/or the lateral direction of the LFD control device (26 in FIG. 1) as it moves through the water. Alternatively, and as will be explained with reference to FIG. 4A, the LFD control device (26 in FIG. 1) may include sensors and circuitry configured to enable automatic adjustment of depth and direction. The embodiment of circuitry in FIG. 4A can include geodetic direction sensing elements Mx, My, such as flux-gate magnetometers, gyroscopes or other directional sensing devices, and a pressure sensor 100 that detects pressure in the water (11 in FIG. 1). Pressure in the water corresponds directly to depth in the water. Signals from each of the directional sensing elements Mx, My and the pressure sensor 100 are coupled through respective preamplifiers 106, 108, 104 to a multiplexer 102. Output of the multiplexer 102 may be digitized in an analog to digital converter 110 for communication to the controller 78. The controller 78 is shown in operative communication with each of two actuators 80, 80B. The first of the actuators 80 is as shown in FIG. 4. The second actuator 80B as explained with reference to FIG. 4 is disposed in the chamber (72 in FIG. 4) circumferentially displaced about 90 degrees from the first actuator 80 and includes a corresponding crankshaft and quick connects (neither shown in the figures). The controller 78 may be in operative communication with a telemetry transceiver 112. The telemetry transceiver 112 is also in signal communication with the induction coil 74 such that signals transmitted by the recording unit (12 in FIG. 1) are detected and communicated to the controller 78, and signals to be transmitted from the controller 78 to the recording unit (12 in FIG. 1) are similarly applied to telemetry in the telemetry transceiver 112 and transmitted through the induction coil 74. The controller 78 may be configured to transmit to the recording unit (12 in FIG. 1) the direction and depth of the LFD control device at selected times.

The embodiment shown FIG. 4A may operate by preprogramming a selected depth and geodetic direction into the controller 78. Such programming may be performed remotely by the system user entering appropriate commands into the recording unit (12 in FIG. 1) or by other communication, such as by applying a signal to appropriate conductors in the cable (54 in FIG. 3). As the LFD control device (26 in FIG. 1) is moved through the water, detected changes from the programmed direction, as determined in the controller 78 from the measurements made by the directional sensing elements Mx, My, result in the controller 78 generating a control signal to operate the one of the actuators 80, 80B that moves the vertically oriented control surfaces (36, 38 in FIG. 1). Correspondingly, change in depth from the programmed depth, as determined in the controller 78 from measurements made by the pressure sensor 100, result in the controller 78 generating a signal to operate the one of the actuators 80, 80B that moves the horizontally oriented control surfaces (34 in FIG. 1). Thus, direction and depth are automatically maintained. The system user may change the programmed depth and/or direction by entering particular commands into the recording unit (12 in FIG. 1) that are ultimately communicated to the controller 78.

In another implementation, a lateral distance between the streamers (20 in FIG. 1) may be automatically maintained by suitable operation of the vertically oriented control surfaces. Automatic operation may be performed using an acoustic ranging device such as shown in FIG. 4C. The chamber 72 may also include therein an acoustic transducer 178 that may emit controlled duration bursts or pings of acoustic energy 160 that may be imparted to the water. When the acoustic energy 160 impacts an adjacent streamer 20, some of the energy is reflected as shown at 162 in FIG. 4C back toward the transducer 178. A two way travel time of the acoustic energy will be related to the distance between the transducer 178 and the adjacent streamer 20. If the lateral distance changes from a predetermined value as determined by the acoustic ranging device, the controller 78 may be programmed to operate the actuator (80 in FIG. 4) or motor (180 in FIG. 4B) to rotate the vertical control surfaces to move the LFD device laterally until the lateral separation between the streamers returns to the predetermined value.

The embodiments explained with reference to FIGS. 4, 4A and 5 use induction coils in each of the inner housing (30 in FIG. 3) and outer housing (32 in FIG. 4) as a communication element to transfer electrical power and signals between the housings (30, 32 in FIG. 2) while enabling free rotation therebetween. It should be clearly understood that other devices known in the art may be used as a communication element to transfer electrical power and signals while enabling relative rotation between the housings. One such device is shown in FIG. 5A. Slip rings 116 made from electrically conductive material may be disposed in the channel 50A in the inner housing 30. The slip rings 116 may be embedded in an electrically non-conductive substrate (not shown) to insulate them from the inner housing 30 and each other and to maintain their positions in the channel 50A. The outer housing 32, in the space used for the induction coil (74 in FIG. 4), may include one or more contact brushes 118. Each contact brush 118 is urged into contact with a corresponding slip ring 116. The brushes 118 may be so urged by a spring 120 disposed between the brush 118 and the interior wall of the outer housing 32. Preferably, the brushes 118 are guided such as by a brush guide 118A to keep the brushes in their longitudinal positions within the outer housing. If slip rings and brushes are used, it may be necessary to provide seals 114 between the inner housing 30 and the outer housing 32 to exclude water from entering the space occupied by the brushes 118 and slip rings 116.

An example of a quick connect is shown in FIG. 6. The quick connect 40 includes a female portion or receptacle 40A that may be rotationally fixedly coupled to one end of the crankshaft (82 in FIG. 5). An interior of the receptacle 40A may include splines 90 that cooperatively engage similar splines 90A on the male portion or pin 40C of the quick connect 40. When assembled, the pin 40C seats in the receptacle 40A and the corresponding splines 90, 90A engage to transfer rotation of the receptacle 40A to the pin 40C. The pin 40C is rotationally fixedly coupled to one of the control surfaces (36 is shown in FIG. 6) so rotation of the receptacle 40A ultimately causes corresponding rotation of the control surface 36. Other types of quick connect are well known in the art and include a D-shaped receptacle and corresponding shaft, for example.

The quick connect provides features to retain the pin 40C in the receptacle 40A that are quickly and easily operated by the user to release the pin 40C from the receptacle 40A. In the present embodiment, a ball sleeve 94 having a tapered inner surface is biased to move longitudinally along the exterior surface of the receptacle 40A by a device such as a coil spring 92. When urged into it endmost position, the tapered inner surface of the ball sleeve 94 moves locking balls 96 radially inwardly. If the pin 40C is seated in the receptacle 40A, the locking balls 96 will be moved into a retaining groove 96A formed on the outer surface of the pin 40C. Thus, the pin 40C will be held in place in the receptacle 40A. To remove the pin (and affixed control surface) all that is needed is to depress the ball sleeve 94 against the spring 92 to enable the locking balls 96 to move radially outwardly from the retaining grove 96A, thus enabling the pin 40C to be easily removed from the receptacle 40A. It is contemplated that all four control surfaces may be quickly and easily removed from each outer housing (32 in FIG. 2) by the user as the streamers (20 in FIG. 1) are withdrawn from the water (11 in FIG. 1). Correspondingly, the control surfaces may be quickly and easily affixed to the outer housing by the reverse operation. It should be clearly understood that the arrangement of pin and receptacle shown in FIG. 6, wherein the pin is affixed to the control surface and the receptacle is affixed to the crankshaft may be reversed, such that the pin is affixed to the crankshaft and the receptacle is fixed to the control surface, without in any way affecting the operation of the quick connect 40.

Another example of a quick connect uses a pin having a substantially hexagonal cross section and a receptacle having a similar cross section to engage the pin. The corresponding cross sections of such pin and receptacle enable transfer of rotational motion from the pin to the receptacle and vice versa. An example of the foregoing type of quick connect is disclosed in U.S. Pat. No. 6,695,321 issued to Bedi et al., incorporated herein by reference.

During operation of the system, and referring once again to FIG. 1, control signals may be communicated to one or more of the LFD control devices 26 from the recording unit 12. The signals may be decoded by the controller (78 in FIG. 4) and the controller may operate one of the actuators (80 in FIG. 4) to change the depth of the streamer 20, or the other one of the actuators (80B in FIG. 4A) to change the lateral direction of the streamer 20. During deployment of streamers including the LFD control devices according to the various embodiments of the invention, it is contemplated that as the streamers are deployed from respective winches, the control surfaces will be attached as the LFD control device moves past an assembly point. The control surfaces may be attached by hand or may be attached by a suitable machine. During retrieval of such streamers, it is contemplated that as the streamers are spooled onto the winch, the control surfaces will be removed prior to each LFD control device being moved onto the winch. If the outer diameter of the outer housing is not substantially greater than the outer diameter of the streamer, then the LFD control device will not substantially affect spooling the streamer.

In some implementations of the LFD control device, inputs may be included from global positioning system (“GPS”) receivers disposed in other parts of the seismic acquisition system. Position information from the GPS receivers may be communicated to the recording system (12 in FIG. 1). Any movement of any one or more of the LFD devices from the optimal system geometry position may be corrected by the recording system (12 in FIG. 1) sending an appropriate control signal to the improperly positioned LFD device(s) such that the position(s) thereof may be corrected by operating the appropriate control surfaces.

Embodiments of a LFD control device according to the various aspects of the invention may provide improved control over geodetic direction, relative lateral position and depth of a streamer so as to better maintain geometry of a seismic data sensor array, while presenting fewer obstacles to deployment and retrieval of seismic streamers.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A lateral force and depth control device for a seismic streamer, comprising:
an inner housing including a coupling at each longitudinal end thereof, the coupling configured to mate with a corresponding coupling at a longitudinal end of a streamer segment;
an outer housing rotatably supported on the inner housing;
a signal communication element configured to transfer at least one of electrical power and signals between the inner housing and the outer housing while enabling relative rotation therebetween;
a plurality of control surfaces rotatably coupled to the outer housing and arranged about the circumference of the outer housing, the control surfaces coupled to the outer housing by releasable couplings;
a first controllable actuator disposed in the outer housing and functionally coupled to at least a first one of the control surfaces; and
a second controllable actuator disposed in the outer housing and functionally coupled to at least a second one of the control surfaces.

2. The device of claim 1 wherein the releasable couplings comprise quick connects.

3. The device of claim 1 further comprising four control surfaces arranged substantially at right angles to each other around the circumference of the outer housing, and wherein one of the control surfaces is negatively buoyant in water, a circumferentially opposed one of the control surfaces is positively buoyant in water and the two control surfaces orthogonally disposed thereto are substantially neutrally buoyant.

4. The device of claim 3 wherein the first and second controllable actuators each comprises a linear actuator oriented substantially along a direction of a longitudinal axis of the outer housing, and wherein an output of each actuator is coupled through a motion transferring element to a circumferentially opposed pair of the control surfaces.

5. The device of claim 3 wherein the first and second controllable actuators each comprises a servo motor rotationally coupled to a worm gear and ball nut.

6. The device of claim 1 further comprising a controller in signal communication with each of the actuators, the controller configured to generate control signals to operate each actuator so as to rotate the control surfaces to produce a selected lift in depth and a selected lift in geodetic direction.

7. The device of claim 6 wherein the controller is configured to generate the control signals in response to commands transmitted by a seismic data recording unit.

8. The device of claim 6 further comprising at least one geodetic direction sensor and a depth sensor, and wherein the controller is configured to generate the control signals in response to direction and depth signals produced by the respective sensors so as to maintain the device at a selected depth and geodetic direction.

9. The device of claim 1 wherein the signal communication device comprises an induction coil disposed in each of the inner housing and the outer housing.

10. The device of claim 1 wherein the signal communication element comprises at least one slip ring and at least one contact brush cooperatively engaged with the slip ring.

11. The device of claim 1 wherein an outer diameter of the outer housing is substantially equal to an outer diameter of the streamer segment.

12. A seismic sensor system, comprising:
a seismic vessel;
a plurality of seismic streamers deployed behind the seismic vessel and laterally spaced apart from each other, each streamer including a plurality of seismic sensors disposed at spaced apart positions along each streamer, each streamer including at least one lateral force and depth control device, each lateral force and depth control device including:
an inner housing including a coupling at each longitudinal end thereof, the coupling configured to mate with a corresponding coupling at a longitudinal end of a streamer segment,
an outer housing rotatably supported on the inner housing,
a signal communication device configured to transfer at least one of electrical power and signals between the inner housing and the outer housing while enabling relative rotation therebetween,
a plurality of control surfaces rotatably coupled to the outer housing and arranged about the circumference of the outer housing, the control surfaces coupled to the outer housing by releasable couplings,
a first controllable actuator disposed in the outer housing and functionally coupled to at least a first one of the control surfaces, and
a second controllable actuator disposed in the outer housing and functionally coupled to at least a second one of the control surfaces.

13. The system of claim 12 wherein the releasable couplings in each lateral force and depth control device comprise quick connects.

14. The system of claim 12 wherein each lateral force and depth control device further comprises four control surfaces arranged substantially at right angles to each other around the circumference of the outer housing, and wherein one of the control surfaces is negatively buoyant in water, a circumferentially opposed one of the control surfaces is positively buoyant in water and the two control surfaces orthogonally disposed thereto are substantially neutrally buoyant.

15. The system of claim 14 wherein the first and second controllable actuators in each lateral force and depth control device each comprises a linear actuator oriented substantially along a direction of a longitudinal axis of the outer housing, and wherein an output of each actuator is coupled through a motion transferring element to a circumferentially opposed pair of the control surfaces.

16. The system of claim 14 wherein the first and second controllable actuators in each lateral force and depth control device each comprises a servo motor rotationally coupled to a worm gear and a ball nut.

17. The system of claim 11 wherein each lateral force and depth control device comprises a controller in signal communication with each of the actuators, the controller configured to generate control signals to operate each actuator so as to rotate the control surfaces to produce a selected lift in depth and a selected lift in geodetic direction.

18. The system of claim 17 wherein each controller is configured to generate the control signals in response to commands transmitted by a seismic data recording unit.

19. The system of claim 17 further comprising in each lateral force and depth control device at least one geodetic direction sensor and a depth sensor, and wherein the controller is configured to generate the control signals in response to direction and depth signals produced by the respective sensors so as to maintain each lateral force and depth control device at a selected depth and geodetic direction.

20. The system of claim 12 wherein the signal communication device in each lateral force and depth control device comprises an induction coil disposed in each of the inner housing and the outer housing.

21. The system of claim 12 wherein the signal communication device in each lateral force and depth control device comprises at least one slip ring and at least one contact brush cooperatively engaged with the slip ring.

22. The system of claim 12 wherein an outer diameter of the outer housing of each lateral force and depth control device is substantially equal to an outer diameter of the streamer segment.

23. The system of claim 12 wherein each lateral force and depth control device comprises means for measuring a distance between the lateral force and depth control device and an adjacent one of the streamers, and means in operative communication with the means for measuring a distance operable to cause the lateral force and depth control device to move the streamer laterally to maintain a measured distance at a preselected value.

24. The system of claim 23 wherein the means for measuring distance comprises an acoustic transducer and means for measuring a travel time of acoustic energy from the transducer to the adjacent streamer.

25. A method for operating a seismic acquisition system, comprising:
towing a plurality of laterally separated streamers behind a vessel;
determining at least one of a geodetic position and a lateral distance between streamers at selected positions along the length of the streamers; and
operating a lateral force and depth control device proximate at least one of the selected positions to maintain relative lateral positions of the streamers along the lengths thereof.

26. The method of claim 25 wherein the determining geodetic position comprises detecting a global positioning system signal at selected positions along the streamers and operating selected ones of the lateral force and depth control devices in response to the global positioning system signal to maintain a predetermined acquisition system geometry.

27. The method of claim 25 wherein the determining lateral distance comprises measuring acoustic travel time between the selected positions and a streamer laterally adjacent to each of the selected positions.
